(19) United States
(12) Patent Application Publication
(10) Pub. No.: US 2014/0224871 A1
(43) Pub. Date: Aug. 14, 2014

(54) PORTABLE ELECTRONIC APPARATUS, CONTAINING DEVICE, CONTAINING DEVICE IDENTIFYING METHOD, AND IDENTIFICATION SYSTEM THEREOF

(71) Applicant: Wistron Corporation, New Taipei City (TW)

(72) Inventor: Cheng-Chia LAI, New Taipei City (TW)

(73) Assignee: Wistron Corporation, New Taipei City (TW)

(21) Appl. No.: 14/097,758

(22) Filed: Dec. 5, 2013

(30) Foreign Application Priority Data
Feb. 8, 2013 (TW) 102105444

(51) Int. Cl. G06F 17/30; G06K 7/01

(52) U.S. Cl. CPC G06F 17/30; G06K 7/01
USPC 235/380

(57) ABSTRACT

A portable electronic apparatus, a containing device, a containing device identifying method, and an identification system thereof are disclosed. The portable electronic apparatus is disposed in the containing device, wherein the containing device has an identification unit. The portable electronic apparatus includes an environment-sensing module, a processing module, and a reading module. The environment-sensing module is used for sensing an external environment of the portable electronic apparatus for getting a sensing signal. The processing module is used for determining whether the portable electronic device being disposed in the containing device according to the sensing signal. When the portable electronic apparatus is disposed in the containing device, the processing module is used for controlling the reading module to read the identification unit, so as to identify the containing device.

### BACKGROUND OF THE INVENTION

1. Field of the Invention

The present invention relates to a portable electronic apparatus, a containing device identifying method and an identification system thereof, and more particularly relates to a portable electronic apparatus, a containing identifying method and an identification system thereof for automatically detecting different containing devices.

2. Description of the Related Art

Along with the advancement of technology, various portable electronic apparatuses are developed and different corresponding containing devices are produced to work together with these portable electronic apparatuses. Users may hold different portable electronic apparatuses for identification and control. Taking production lines as example, different scheduled classes may be arranged with different portable electronic apparatuses. Such approach, however would cause much more cost because portable electronic apparatuses usually need higher prices. On the other hand, the cost of portable electronic apparatuses and containing devices are different. In convention art, therefore, a public use portable electronic apparatus may correspond to different containing devices for different users. When users use the portable electronic apparatuses, they adjust the settings of the portable electronic apparatuses. But, such setting approach may be too tedious for users and portable electronic apparatuses may be unable to use when users make wrong settings.

Therefore, there is a need of a portable electronic apparatus, a containing device identifying method, and an identification system capable of detecting different containing devices therefore to solve the problem of conventional art.

### SUMMARY OF THE INVENTION

One of major objectives of the present invention is to provide a portable electronic apparatus capable of automatically detecting different containing devices.

Another major objective of the present invention is to provide a containing device identifying method.

Another major objective of the present invention is to provide an identification system that implements the aforementioned containing device identification method.

Another major objective of the present invention is to provide a containing device used in the aforementioned identification system.

To achieve the aforementioned objectives, the present invention includes an embodiment of a portable electronic apparatus for being disposed in a containing device, wherein the containing device has an identification unit. The portable electronic apparatus includes an environment-sensing module, a processing module and a reading module. The environment-sensing module is used for obtaining a sensing signal. The processing module is electrically connected to the environment-sensing module for determining whether the portable electronic apparatus is disposed in the containing device according to the sensing signal. The reading module is electrically connected to the processing module. When the processing module determines the portable electronic apparatus is disposed in the containing device, the processing module controls the reading module to read the identification unit so as to identify the containing device.

The containing device identifying method of the present invention includes the steps of: detecting whether a portable electronic apparatus has an environment-sensing module; if detected, detecting whether the portable electronic apparatus is disposed in the containing device by the environment-sensing module to; and if the environment-sensing module is detected, reading the identification unit to identify the containing device.

An identification system of the present invention includes a containing device and a portable electronic apparatus. The containing device has an identification unit. The portable electronic apparatus may be disposed in the containing device. The portable electronic apparatus includes an environment-sensing module, a processing module and a reading module. The environment-sensing module is used for obtaining a sensing signal. The processing module is electrically connected to the environment-sensing module for determining whether the portable electronic apparatus is disposed in the containing device according to the sensing signal. The reading module is electrically connected to the processing module. When the processing module determines the portable electronic apparatus is disposed in the containing device, the processing device controls the reading module to read the identification unit so as to identify the containing device.

A containing device according to the present invention is used in an identification system for storing a portable electronic apparatus. The portable electronic apparatus includes a processing module and a reading module. The containing device includes an identification unit. When the processing module determines the portable electronic apparatus is disposed in the containing device, the processing module controls the reading module to read the identification unit so as to identify the containing device.

### BRIEF DESCRIPTION OF THE DRAWINGS

FIG. 1 illustrates a system architecture diagram of an identification system according to the present invention;

FIG. 1A illustrates outward appearance diagram of a portable electronic apparatus according to the present invention;

FIGS. 2A-2B illustrate a portable electronic apparatus according to the present invention being disposed in a containing device as a first embodiment;

FIG. 2C illustrates a second embodiment for a portable electronic apparatus according to the present invention being disposed in a containing device;

FIGS. 3A-3B illustrate a third embodiment for a portable electronic apparatus being disposed in a containing device;

FIG. 4 is a flowchart illustrating steps of a containing device identification method according to the present invention;

FIG. 4A is a flowchart illustrating steps of a first detection flow for detecting whether a portable electronic apparatus is correctly disposed in a containing device;

FIG. 4B is a flowchart illustrating steps of a second detection flow for detecting whether a portable electronic apparatus is correctly disposed in a containing device; and

FIG. 4C is a flowchart illustrating steps of a third detection flow for detecting whether a portable electronic apparatus is correctly disposed in a containing device.

### DETAILED DESCRIPTION OF THE PREFERRED EMBODIMENTS

To better explain the aforementioned and other objectives, features and advantages of the present invention, various embodiments are explained as follows accompanied with corresponding drawings.

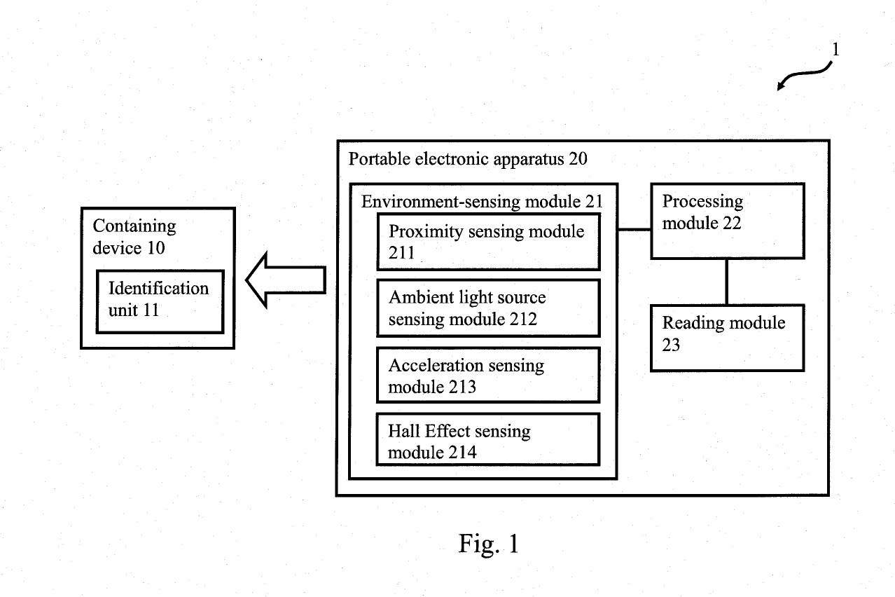

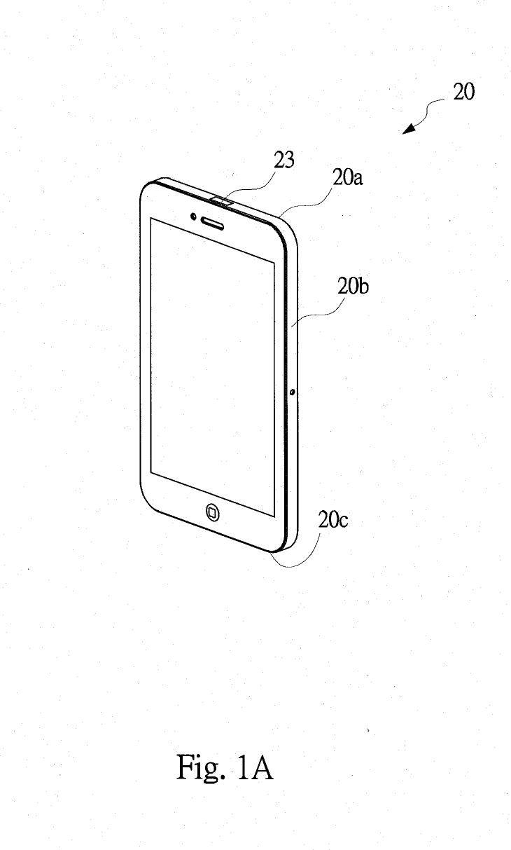

Please refer to FIG. 1, which illustrates a system architecture diagram of an identification system according to the present invention.

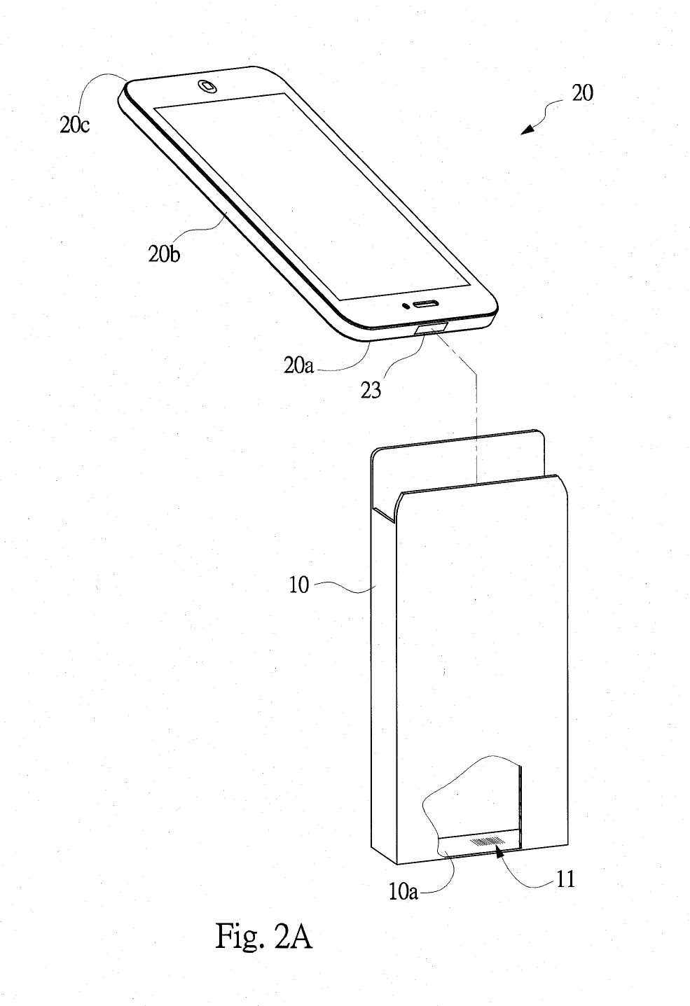

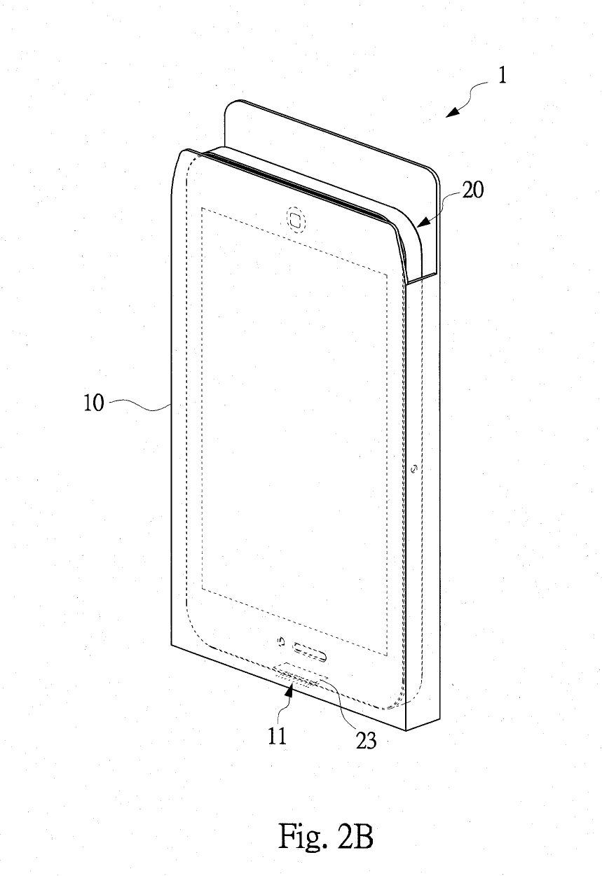

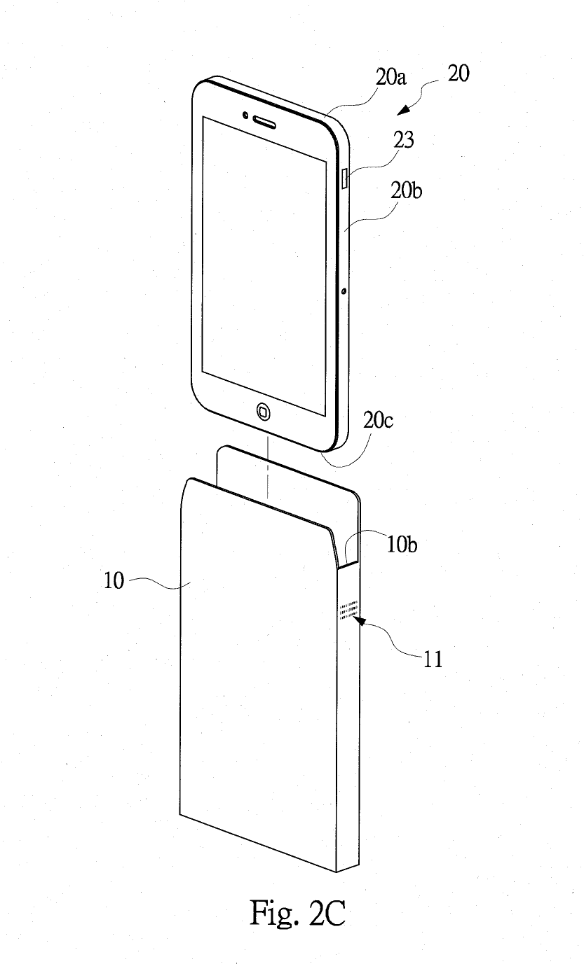

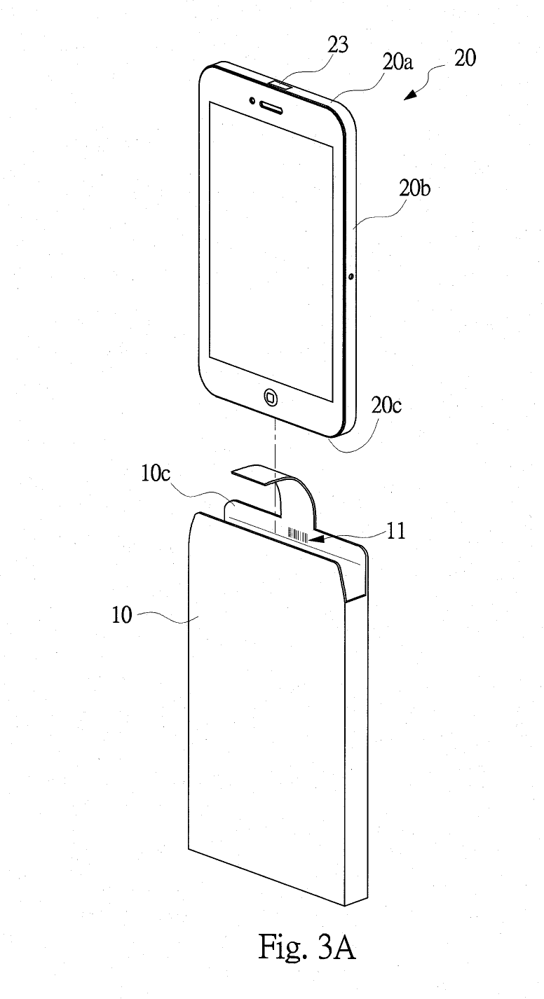

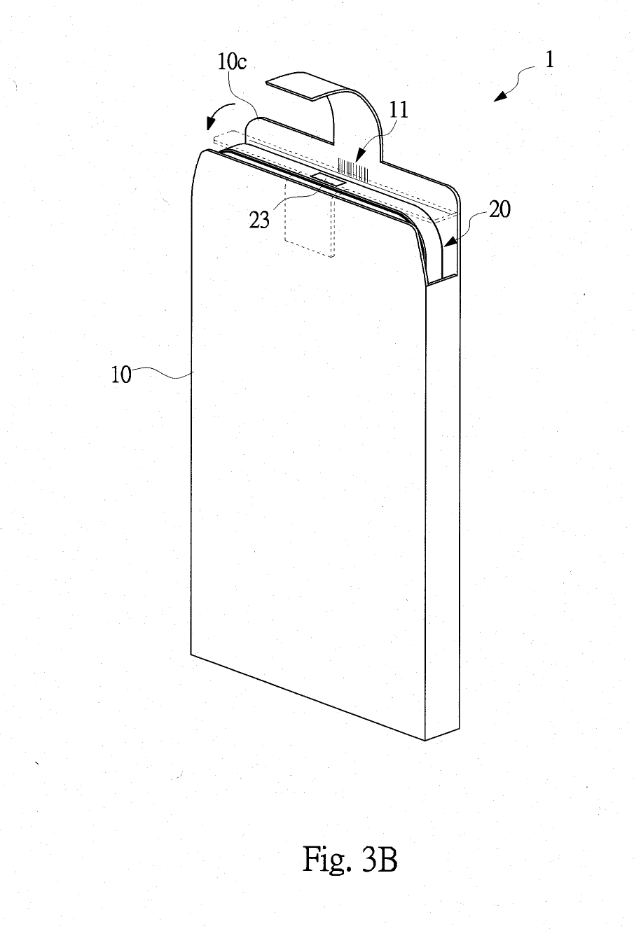

The identification system 1 includes a containing device 10 and a portable electronic apparatus 20. The containing device 10 is used for storing a portable electronic apparatus 20. The containing device 10 has an identification unit 11. The identification unit 11 may be disposed in the bottom portion 10a, lateral portion 10b (as shown in FIG. 2C), or top portion 10c (as shown in FIG. 3A) of the containing device 10, but the present invention is not limited to such configuration. The identification unit 11 may be a barcode, like one-dimension barcode or two-dimension barcode, and may be identifiable geometric graph. The portable electronic apparatus 20 may be an intelligent mobile communication device, a personal digital assistant (PDA) or alike, which may have a size fitting to the containing device 10 to be disposed in the containing device 10. The portable electronic apparatus 20 includes an environment-sensing module 21, a processing module 22, and a reading module 23. The environment-sensing module 21 is used for sensing an external environment of the portable electronic apparatus 20 for obtaining the sensing signal. The processing module 22 may be implemented with hardware, hardware combined with software, or hardware combined with firmware. The portable electronic apparatus 20 may be implemented as a downloaded application (app) for achieving the function of the processing module 22 of the present invention. The present invention, however, is not limited to only such configurations. The processing module 22 is electrically connected to the environment-sensing module 21 and determines whether the portable electronic apparatus 20 is disposed in the containing device 10 according to the sensing signal.

The reading module 23 is electrically connected to the processing module 22 and disposed at the surface of the portable electronic apparatus 20. The reading module 23 is designed corresponding to the type of the identification unit 11. Please also refer to FIG. 1A, which is an outward appearance diagram of a portable electronic apparatus according to the present invention.

The appearance of the portable electronic apparatus 20 is divided into a top portion 20a and a bottom portion 20c. The reading module 23 is disposed in the top portion 20a of the portable electronic apparatus 20. To match the position of the identification unit 11, the reading module 23 may also be disposed in the lateral portion 20b or the bottom portion 20c. The present invention, however, is not limited to such configurations. After the processing module 22 ascertains the portable electronic apparatus 20 being disposed in the containing device 10, which means when the position of the reading module 23 of the portable electronic apparatus 20 may be close or directly facing against the identification unit 11 of the containing device 10, the processing module 22 controls the reading module 23 to read the identification unit 11 so as to identify the containing device 10.

The environment-sensing module 21 includes a proximity sensing module 211, an ambient light source sensing module 212, an acceleration sensing module 213 and a Hall Effect sensing module 214. The environment-sensing module 21 may include all above mentioned modules or include only a portion of these modules. The present invention, however, is not limited to such configurations. The proximity sensing module 211 is used for emitting an infrared light for detecting whether there is an external object approaching. When the external object is close to a threshold value, the proximity sensing module 211 senses a proximity sensing signal representing an object approaching, such that the proximity sensing module 211 is able to determine whether the portable electronic apparatus is disposed in the containing device 10.

On the other hand, the proximity sensing module 211 may be replaced with an ambient light source sensing module 212. The ambient light source sensing module 212 is used for detecting lightness of environment light source for sensing a light source sensing signal. Therefore, when the portable electronic apparatus 20 is disposed in the containing device 110, in which the portable electronic apparatus 20 is in a dark environment, the ambient light source sensing module 212 is able to detect light source sensing signal representing darkness. The acceleration sensing module 213 is used for detecting the direction for the portable electronic apparatus 20 is placed. In an embodiment of the present invention, the acceleration sensing module 213 is designed corresponding to the proximity sensing module 211 or the ambient sensing module 212. Therefore, when the portable electronic apparatus 20 is disposed in the containing device 10, the acceleration sensing module 213 determines whether the portable electronic apparatus is heading to a specific direction so that the reading module is able to read the identification unit 11. The specific direction refers to the direction a user normally place the portable electronic apparatus 20. For example, the specific direction is substantially parallel to a horizontal surface or vertical to the horizontal surface. But, the present invention is not limited to such configuration.

FIGS. 2A-2B are taken as examples. FIGS. 2A-2B illustrate a first embodiment in which a portable electronic apparatus is disposed in the containing device according to the present invention.

In FIG. 2A, the identification unit 11 is exemplified as a one-dimension barcode, but the present invention is not limited to such configuration. When the identification unit 11 is disposed in the bottom portion 10a of the containing device 10 and the reading module 23 is disposed on the top bottom 20a of the portable electronic apparatus 20, the acceleration module 213 senses whether portable electronic apparatus 20 is heading down into the containing device 10 so that the reading module 23 is able to scan the identification unit 11. If the portable electronic apparatus 20 is heading down into the containing device 10, the processing module 22 is able to ascertain the position to the place the portable electronic apparatus is correct. Next, the processing module 22 is then able to control the reading module 23 to scan the identification unit 11.

FIG. 2C illustrates a second embodiment in which a portable electronic apparatus is disposed in the containing device according to the present invention.

On the other hand, the identification unit 11 may be placed in the lateral portion 10b of the containing device 10. In this example, the reading module 23 is disposed in the lateral portion 20b of the portable electronic apparatus 20 for matching the position of the identification unit 11.

Next, please refer to FIGS. 3A-3B, which illustrate a third embodiment in which a portable electronic apparatus is disposed in a containing device according to the present invention.

Besides, the identification unit 11 may also be disposed in the top portion 10c of the containing device 10. The top portion 10c may be a cover body or a fastener belt with a fastener. The present invention, however, is not limited to such configuration. Therefore, in the third embodiment, the acceleration sensing module 213 senses whether the portable electronic apparatus 20 is heading upwardly into the containing device 10. If the portable electronic apparatus 20 is heading upwardly into the containing device 10, when the top portion 10c of the containing device 10 is closed, the processing module 22 is then able to control the reading module 23 to scan the identification unit 11 of the containing device 10. Please be noted that the present invention is not limited to the configuration that the containing device 10 contains a single identification unit 11. The identification unit 11 may be disposed in the bottom portion 10a, the lateral portion 10b or the top portion 10c at the same time for matching different portable electronic apparatuses 20.

Besides, the environment-sensing module 21 may also be a Hall Effect sensing module 214. The Hall Effect sensing module is used for sensing whether there is magnetic force. Correspondingly, the containing device 10 needs to be disposed with a magnet in corresponding position. Therefore, when the portable electronic apparatus is disposed in the containing device 10, the Hall Effect sensing module 214 is able to sense the magnet for informing the processing module 22.

Because the aforementioned proximity sensing module 211, the ambient light source sensing module 212, the acceleration sensing module 213 and the Hall Effect sensing module 214 are known to persons of ordinary skill in the art, their operation details are not repeated here for clarity. When the environment-sensing module 21 uses any of the aforementioned method to detect the portable electronic apparatus 20 being disposed in the containing device 10, the processing module 22 is able to control the reading module 23 to scan the containing device 20 so that the portable electronic apparatus 20 may automatically adjust correspondingly.

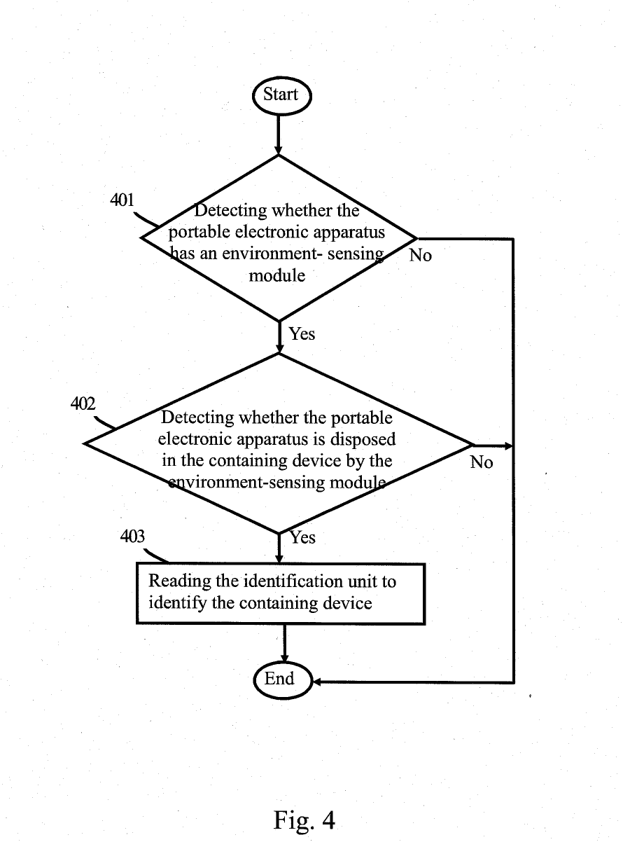

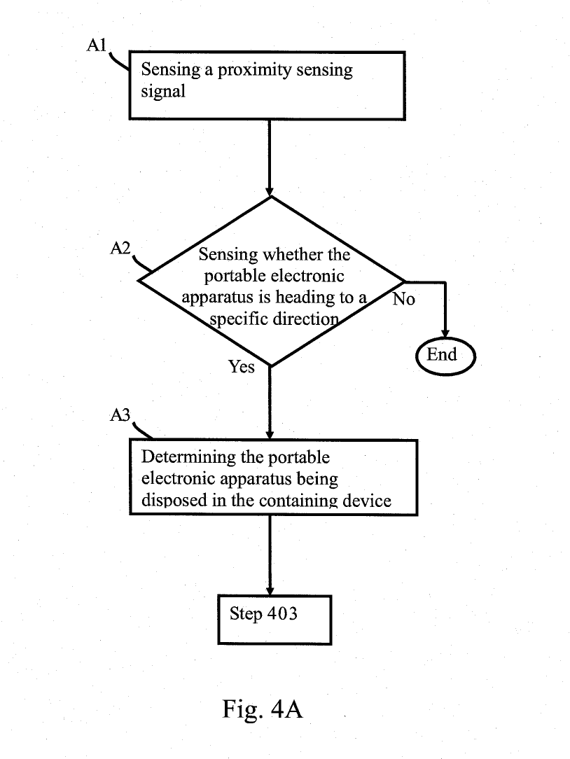

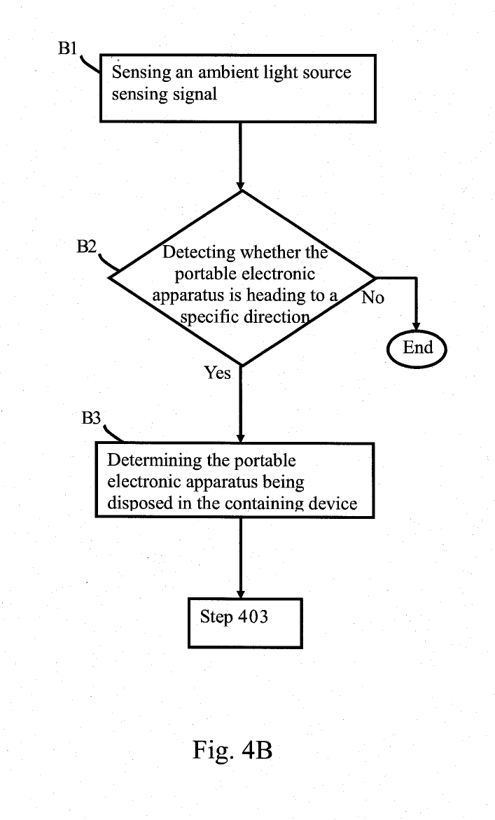

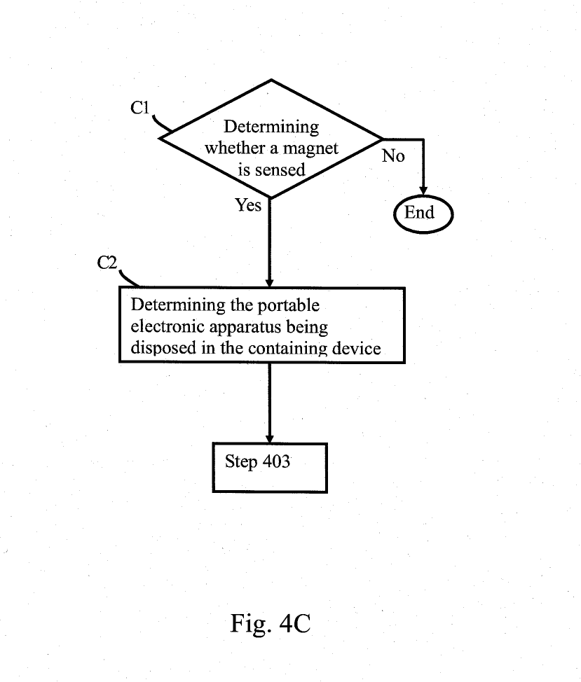

Next, please refer to FIG. 4, which is a flowchart of a containing device identification method according to the present invention. Please be noted that although the portable electronic apparatus 20 is used as an example for explaining the containing device identification method, but the containing device identification method is not limited only to portable electronic apparatus 20.

Firstly, step 401 is performed for detecting whether the portable electronic apparatus has an environment-sensing module.

When the portable electronic apparatus 20 is powered on, the processing module firstly determines whether the portable electronic apparatus 20 has a environment-sensing module 21, i.e. having any of a proximity sensing module 211, an ambient light source sensing module 212, an acceleration sensing module 213, or a Hall Effect sensing module 214. If the portable electronic apparatus 20 does not have the environment-sensing module 21, the portable electronic apparatus 20 would not be able to continue the following procedures.

If the portable electronic apparatus 20 has an environment-sensing module 21, step 402 is performed for detecting whether the portable electronic apparatus is disposed in the containing device by the environment-sensing module.

The environment-sensing module 21 obtains the sensing signal by scanning an external environment of the portable electronic apparatus 20. The processing module 22 determines whether the portable electronic apparatus 20 is disposed in the containing device 10 according to the sensing signal. According to different types of the environment-sensing module 21, the step 402 has different processing flows.

Please refer to FIG. 4A, which flowchart illustrates a first detection flow for detecting whether the portable electronic apparatus is disposed in the containing device.

If the environment-sensing module 21 is the proximity sensing module 211 and the acceleration sensing module 213, the step A1 is performed for sensing the proximity sensing signal.

Firstly, the proximity sensing module 211 detects a proximity sensing signal representing an object approaching so as to acknowledge that the portable electronic apparatus is disposed in the containing device 10.

Next, step A2 is performed for sensing whether the portable electronic apparatus is heading to a specific direction.

Next, the acceleration sensing module 213 detects the status of the portable electronic apparatus 20. For example, the portable electronic apparatus 20 is sensed whether it is placed downwardly into the containing device 10 to determine whether the position for placing the portable electronic apparatus 20 is correct. If the acceleration sensing module 213 detects that the portable electronic apparatus 20 is not heading to the specific direction, which means that the reading module 23 is unable to scan corresponding identification unit 11. The detection flow therefore can be ended.

If the portable electronic apparatus 20 is detected heading to the specific direction, the step A3 is performed for determining the portable electronic apparatus being disposed in the containing device.

Finally, the acceleration sensing module 213 gets the sensing signal to inform the processing module 22. With the processing module 22, it can be determined that the portable electronic apparatus 20 has been disposed in the containing device 10 and step 403 is performed.

Besides, please refer to FIG. 4B, which flowchart illustrates a second detection flow of detecting whether the portable electronic apparatus is disposed in the containing device.

If the environment-sensing module 21 is the ambient light source module 212 and the acceleration sensing module 213, the step B1 is firstly performed for sensing an ambient light source sensing signal.

Firstly, the ambient light source sensing module 212 detects an external light source sensing signal representing darkness of the environment so as to determine the portable electronic apparatus 20 being disposed in the containing device 10.

Next, the step B2 is performed for detecting whether the portable electronic apparatus is heading to a specific direction.

Next, the acceleration sensing module 213 senses the status of the portable electronic apparatus 20 to determine whether the portable electronic apparatus 20 is placed correctly. If the acceleration sensing module 213 detects that the portable electronic apparatus 20 is not heading to the specific direction, which means the reading module is not able to scan corresponding identification unit 11. The detection flow is therefore ended.

If the portable electronic apparatus 20 is detected heading to the specific direction, the step B3 is performed for determining the portable electronic apparatus being disposed in the containing device.

Finally, the acceleration sensing module 213 senses the sensing signal and informs the processing module 22. With the processing module 22, the portable electronic apparatus 20 is determined disposed in the containing device and the step 403 is performed.

Next, please refer to FIG. 4C, which flowchart illustrates a third detection flow for detecting whether the portable electronic apparatus is disposed in the containing device.

If the environment-sensing module 21 is a Hall Effect sensing module 214 and the containing device 10 has a corresponding magnet, the step C1 is firstly performed for determining whether a magnet is sensed.

Firstly, the Hall Effect sensing module 214 senses the environment to detect whether the magnet of the containing device 10 is sensed. If the magnet of the containing device 10 is not sensed, which means that the portable electronic apparatus 20 is not placed in the containing device 10, the detection flow may therefore be ended.

If the Hall Effect sensing module 214 detects the magnet of the containing device 10, the step C2 is performed for determining the portable electronic apparatus being disposed in the containing device.

Finally, the Hall Effect sensing module 214 obtains a sensing signal and informs the processing module 22. With the processing module 22, the portable electronic apparatus 20 is determined disposed in the containing device 10 and the step 403 is performed.

Finally, after the aforementioned first to third embodiments, when the processing module 22 determines that the portable electronic apparatus 20 is disposed in the containing device 10, the step 403 is performed for reading the identification unit to identify the containing device.

Finally, the processing module 22 controls the reading module 23 to read the identification unit 11 of the containing device 10 for identifying the containing device. Accordingly, the portable electronic apparatus may perform corresponding processing according to different containing devices 10.

Please be noted that the containing device identifying method is not limited to the aforementioned step order. The order or steps may be changed once the objective of the present invention may be achieved.

Therefore, with the apparatus and method according to the present invention, the portable electronic apparatus 20 may perform corresponding processing with respect to different containing devices 10. Users do not need to perform complex settings.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A portable electronic apparatus for being disposed in a containing device, wherein the containing device has an identification unit, the portable electronic apparatus comprising:
an environment-sensing module for getting a sensing signal;
a processing module electrically connected to the environment-sensing module for determining whether the portable electronic apparatus being disposed in the containing device according to the sensing signal; and
a reading module electrically connected to the processing module, when the processing module determining the portable electronic apparatus being disposed in the containing device, the processing module controlling the reading module to read the identification unit so as to identify the containing device.

2. The portable electronic apparatus as claimed in claim 1, wherein the environment-sensing module comprises:
a proximity sensing module for sensing a proximity sensing signal for detecting whether the portable electronic apparatus being disposed in the containing device; and
an acceleration sensing module, when the proximity sensing module sensing the proximity sensing signal, the acceleration sensing module being used for sensing whether the portable electronic apparatus being heading to a specific direction so as to detect whether the portable electronic apparatus being disposed in the containing device.

3. The portable electronic apparatus as claimed in claim 1, wherein the environment-sensing module comprises:
an ambient light source sensing module for detecting a light source sensing signal to detect whether the portable electronic apparatus being disposed in the containing; and
an acceleration sensing module, when the ambient light source sensing module sensing the light source sensing signal, the acceleration sensing module being used for sensing whether the portable electronic apparatus heading to a specific direction so as to detect whether the portable electronic apparatus being disposed in the containing.

4. The portable electronic apparatus as claimed in claim 1, wherein the environment-sensing module comprises a Hall Effect sensing module, the containing device comprises a magnet, and the Hall Effect sensing module is used for sensing the magnet for detecting whether the portable electronic apparatus is disposed in the containing device.

5. A method of containing device identification for a portable electronic apparatus to identify a containing device, wherein the containing device is disposed with an identification unit, the method comprising:
detecting whether the portable electronic apparatus has an environment-sensing module;
if the environment-sensing module is detected, detecting whether the portable electronic apparatus is disposed in the containing device by the environment-sensing module; and
if the environment-sensing module is detected, reading the identification unit for identifying the containing device.

6. The method of containing device identification as claimed in claim 5, wherein when the portable electronic apparatus is detected having a proximity sensing module and an acceleration sensing module, the step of detecting whether the portable electronic apparatus is disposed in the containing device further comprises:
sensing a proximity sensing signal;
detecting whether the portable electronic device is heading to a specific direction; and
if the portable electronic apparatus is heading to the specific direction, determining the portable electronic apparatus is disposed in the containing device.

7. The method of containing device identification as claimed in claim 5, wherein when the portable electronic apparatus is detected having an ambient light source sensing module and an acceleration sensing module, the step of detecting whether the portable electronic apparatus is disposed in the containing device further comprises:
sensing an external light source sensing signal;
detecting whether the portable electronic apparatus is heading to a specific direction; and
if the portable electronic apparatus is heading to the specific direction, determining the portable electronic apparatus is disposed in the containing device.

8. The method of containing device identification as claimed in claim 5, wherein when the portable electronic apparatus is detected having a Hall Effect sensing module, the step of detecting whether the portable electronic apparatus is disposed in the containing device further comprises:
determining whether a magnet is sensed; and
if the magnet is sensed, determining the portable electronic apparatus is disposed in the containing device.

9. An identification system comprising:
a containing device having an identification unit; and
a portable electronic apparatus for being disposed in the containing device, the portable electronic apparatus comprising:
an environment-sensing module for obtaining a sensing signal;
a processing module electrically connected to the environment-sensing module for determining whether the portable electronic apparatus being disposed in the containing device; and
a reading module electrically connected to the processing module, when the processing module determining the portable electronic apparatus being disposed in the containing device, the processing module controlling the reading module to read the identification unit so as to identify the containing device.

10. The identification system as claimed in claim 9, wherein the environment-sensing module comprises:
a proximity sensing module for sensing a proximity sensing signal to detect whether the portable electronic apparatus being disposed in the containing device; and
an acceleration sensing module, when the proximity sensing module sensing the proximity sensing signal, the acceleration sensing module being used for sensing whether the portable electronic apparatus being heading to a specific direction so as to detect whether the portable electronic apparatus being disposed in the containing device.

11. The identification system as claimed in claim 9, wherein the environment-sensing module comprises:
an ambient light source sensing module for sensing a light source sensing signal to detect whether the portable electronic apparatus being disposed in the containing device; and
an acceleration sensing module, when the ambient light source sensing module detecting the light source sensing signal, the acceleration sensing module being used for detecting whether the portable electronic apparatus being heading to a specific direction to detect whether the portable electronic apparatus being disposed in the containing device.

12. The identification system as claimed in claim 9, wherein the environment-sensing module comprises a Hall Effect sensing module, the containing device has a magnet, the Hall Effect sensing module is used for sensing the magnet for detecting whether the portable electronic apparatus is disposed in the containing device.

13. The identification system as claimed in claim 9, wherein the identification unit is a bar code, and the reading module is a bar code scanning module.

14. The identification system as claimed in claim 9, wherein the containing device further comprises a bottom portion and a lateral portion, and the identification unit is disposed in the bottom portion or the lateral portion.

15. The identification system as claimed in claim 9, wherein the containing device has a top portion, and the identification unit is disposed in the top portion.

16. The identification system as claimed in claim 10, wherein the specific direction is substantially parallel to a horizontal plane or vertical to the horizontal surface.
